(19) United States
(12) Patent Application Publication
(10) Pub. No.: US 2026/0141411 A1
(43) Pub. Date: May 21, 2026

(54) STAY POI ESTIMATION DEVICE

(71) Applicant: NTT DOCOMO, INC., Tokyo (JP)

(72) Inventors: Yusuke NAKAMURA, Chiyoda-ku (JP); Tetsuya YAMAGUCHI, Chiyoda-ku (JP); Akinari SAKAI, Chiyoda-ku (JP)

(73) Assignee: NTT DOCOMO, INC., Tokyo (JP)

(21) Appl. No.: 18/881,123

(22) PCT Filed: May 9, 2023
(86) PCT No.: PCT/JP2023/017466

§ 371 Date: Jan. 3, 2025

(30) Foreign Application Priority Data
Aug. 30, 2022 (JP) 2022-137076

(51) Int. Cl. G06Q 30/0201

(52) U.S. Cl. CPC G06Q 30/020112

(57) ABSTRACT

A stay POI estimation device 1 includes an estimation unit 12 estimating a stay POI that is a POI in which a user stays in an unassociated stay that is a stay not associated with the POI, among stays included in user information that is a chronological history of a stay during movement of each user, a part of which is associated with the POI in which the user stays, and adjacency of each user to other users, on the basis of the user information, the estimation unit 12 performing a simulation assuming that the user moves via a POI candidate that is a candidate of the stay POI for each user, and estimating the stay POI from the POI candidate, on the basis of a chronological match between adjacency between users extracted in the simulation and adjacency included in the user information.

### TECHNICAL FIELD

One aspect of the present disclosure relates to a stay POI estimation device estimating a point of interest (POI) in which a user stays.

### BACKGROUND ART

In Patent Literature 1 described below, a POI attribute determination device is disclosed in which whether the attribute of a POI that is the current position is a POI with a long duration or high frequency of stay or a POI with a short duration or low frequency of stay is determined for a user.

### CITATION LIST

### Patent Literature

Patent Literature 1: Japanese Unexamined Patent Publication No. 2011-154004

### SUMMARY OF INVENTION

### Technical Problem

The POI attribute determination device determines whether the POI is the POI with a long duration or high frequency of stay or the POI with a short duration or low frequency of stay for the user, but for example, is not capable of estimating a POI in which the user stays. Therefore, it is desirable to estimate the POI in which the user stays.

### Solution to Problem

A stay point of interest (POI) estimation device according to one aspect of the present disclosure, includes an estimation unit estimating a stay POI that is a POI in which a user stays in an unassociated stay that is a stay not associated with the POI, among stays included in user information that is a chronological history of a stay during movement of each user, a part of which is associated with the POI in which the user stays, and adjacency of each user to other users, on the basis of the user information, the estimation unit performing a simulation assuming that the user moves via a POI candidate that is a candidate of the stay POI for each user, and estimating the stay POI from the POI candidate, on the basis of a chronological match between adjacency between users extracted in the simulation and adjacency included in the user information.

In such an aspect, the POI in which the user stays in the stay not associated with the POI among the stays during the movement of the user is estimated. That is, it is possible to estimate the POI in which the user stays.

### Advantageous Effects of Invention

According to one aspect of the present disclosure, it is possible to estimate the POI in which the user stays.

### BRIEF DESCRIPTION OF DRAWINGS

FIG. 1 A diagram illustrating an example of a system configuration of a stay POI estimation system including a stay POI estimation device according to an embodiment.

FIG. 2 A diagram illustrating a simple usage image of the stay POI estimation device according to the embodiment.

FIG. 3 A diagram illustrating an example of a functional configuration of the stay POI estimation device according to the embodiment.

FIG. 4 A diagram illustrating a table example of visit POI information (1) of a user X.

FIG. 5 A diagram illustrating a table example of visit POI information (1) of a user Y.

FIG. 6 A diagram illustrating an (first) example of map data.

FIG. 7 A diagram illustrating an (second) example of the map data.

FIG. 8 A diagram illustrating decomposition of the map data illustrated in FIG. 7 into node links.

FIG. 9 A diagram illustrating a table example of a weighted adjacency matrix corresponding to the node links illustrated in FIG. 8.

FIG. 10 A flowchart illustrating an example of a store candidate extraction algorithm executed by the stay POI estimation device according to the embodiment.

FIG. 11 A diagram illustrating a table example of visit POI information (1) of a user A.

FIG. 12 A diagram illustrating another table example of the visit POI information (1) of the user A.

FIG. 13 A diagram illustrating a table example of visit POI information (2) of the user X.

FIG. 14 A diagram illustrating a table example of visit POI information (2) of the user Y.

FIG. 15 A diagram illustrating a table example of visit POI information (3) of the user X.

FIG. 16 A diagram illustrating an example of a route for a brute-force simulation according to store candidates of each user.

FIG. 17 A diagram illustrating an example of input data of the simulation.

FIG. 18 A diagram illustrating a table example of a trial pattern.

FIG. 19 A diagram illustrating a table example of a contact log.

FIG. 20 A diagram illustrating an example of comparison between a log result of the contact log and actual performance.

FIG. 21 A flowchart illustrating an example of a walking simulation algorithm executed by the stay POI estimation device according to the embodiment.

FIG. 22 A diagram illustrating decomposition of an (third) example of the map data into the node links.

FIG. 23 A diagram illustrating a table example of a trial pattern in which a difference from the actual performance is hatched.

FIG. 24 A diagram illustrating a table example of visit POI information (4) of the user X.

FIG. 25 A sequence diagram illustrating an example of a processing flow executed by the stay POI estimation system including the stay POI estimation device according to the embodiment.

FIG. 26 A diagram illustrating an example of a hardware configuration of a computer used in the stay POI estimation device according to the embodiment.

### DESCRIPTION OF EMBODIMENTS

Hereinafter, an embodiment of the present disclosure will be described in detail with reference to the drawings. Note that in the description of the drawings, the same reference numerals will be applied to the same elements, and the repeated description will be omitted. In addition, the embodiment of the present disclosure in the following description is a specific example of the present invention, and the present invention is not limited to the embodiment unless otherwise specified to limit the present invention.

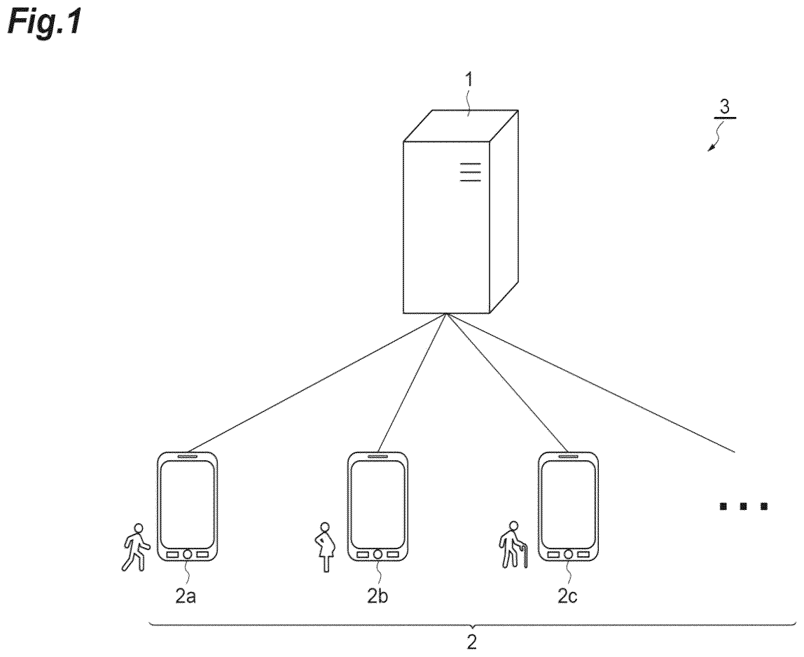

FIG. 1 is a diagram illustrating an example of a stay POI estimation system 3 including a stay POI estimation device 1 according to an embodiment. As illustrated in FIG. 1, the stay POI estimation system 3 is configured by including a stay POI estimation device 1 and one or more mobile terminals 2 (a mobile terminal 2a, a mobile terminal 2b, a mobile terminal 2c, . . . will be suitably referred to as a mobile terminal 2 in an all-inclusive term). The stay POI estimation device 1 and each of the mobile terminals 2 are connected to each other by a network such as a mobile communication network such that communication is available, and are capable of transmitting and receiving information to and from each other.

The stay POI estimation device 1 is a computer device (a server) estimating a POI in which a user stays. The user is a person using a function or a service provided by the stay POI estimation device 1. Each user carries the mobile terminal 2. The stay indicates remaining for a certain period. The stay may indicate not (substantially) moving. The POI is a specific place considered by someone as convenient or interesting. In this embodiment, a store is assumed as the POI, but the POI is not limited thereto. The store, for example, is a building for setting products, a building or an area for providing services, or the like. The details of the stay POI estimation device 1 will be described below.

The mobile terminal 2 is a mobile communication terminal performing mobile communication or a computer device such as a laptop computer. In this embodiment, a smart phone is assumed as the mobile terminal 2, but the mobile terminal is not limited thereto. The mobile terminal 2 is carried by each user as described above.

The mobile terminal 2 is capable of performing near-field wireless communication by Bluetooth (Registered Trademark) low energy (BLE), which is a part of Bluetooth (Registered Trademark), or the like. In a case where the mobile terminals 2 fall within a certain distance range, the mobile terminals 2 automatically exchange identification information of the own terminal with each other by the near-field wireless communication without the operation of the user or the like. Falling within the certain distance range is also referred to as being in contact with each other or adjacent to each other. It is indicated that each of the mobile terminals 2 is in contact with the opponent mobile terminal 2 or the user of the mobile terminal 2 is in contact with the user of the opponent mobile terminal 2 by exchanging the identification information of the own terminal. In this embodiment, a user ID for identifying the user carrying the mobile terminal 2 is used as the identification information of the own terminal (the mobile terminal 2), but the identification information is not limited thereto.

The mobile terminal 2 (assumed as the mobile terminal 2a) generates BLE contact information relevant to contact between users, on the basis of a user ID (a contact user ID) of the user carrying the mobile terminal 2b, which is received from the mobile terminal 2b when the mobile terminal 2 is in contact with another mobile terminal 2 (assumed as the mobile terminal 2b). In the BLE contact information, for example, the user ID of the user carrying the mobile terminal 2 (for example, the mobile terminal 2a) that is the own terminal, a contact date and time that is a date and time when the mobile terminal 2 is in contact with another mobile terminal 2 (for example, the mobile terminal 2b or the like), and the contact user ID that is the user ID of the user carrying the another mobile terminal 2 are associated with each other. The mobile terminal 2 transmits the BLE contact information to the stay POI estimation device 1 periodically (for example, every minute). The BLE contact information may be referred to as a BLE log.

In addition, the mobile terminal 2 may have functions, sensors, or the like provided in a general smart phone, such as an electrical wave positioning function, a positioning function of a global positioning system (GPS), a payment function, or an acceleration sensor, and may transmit information or the like acquired by such functions or sensors to the stay POI estimation device 1.

For example, when the user of the mobile terminal 2 makes a payment in a store by using the payment function, the mobile terminal 2 transmits payment information in which the user ID of the user, a date and time when the payment is made, and a store ID for identifying the store are associated with each other to the stay POI estimation device 1. Note that the payment information may be transmitted to the stay POI estimation device 1 by a device on the store side.

In addition, for example, the mobile terminal 2 transmits position information in which a latitude and a longitude obtained by the positioning function of the GPS and the current date and time are associated with each other to the stay POI estimation device 1 periodically (for example, once per minute).

In addition, for example, the mobile terminal 2 transmits acceleration information in which the acceleration of the own terminal obtained by the acceleration sensor and the current date and time are associated with each other to the stay POI estimation device 1 periodically (for example, once per minute). The acceleration information, instead of the acceleration or in addition to the acceleration, may include the state of the own terminal based on the acceleration, for example, whether the user is staying or moving.

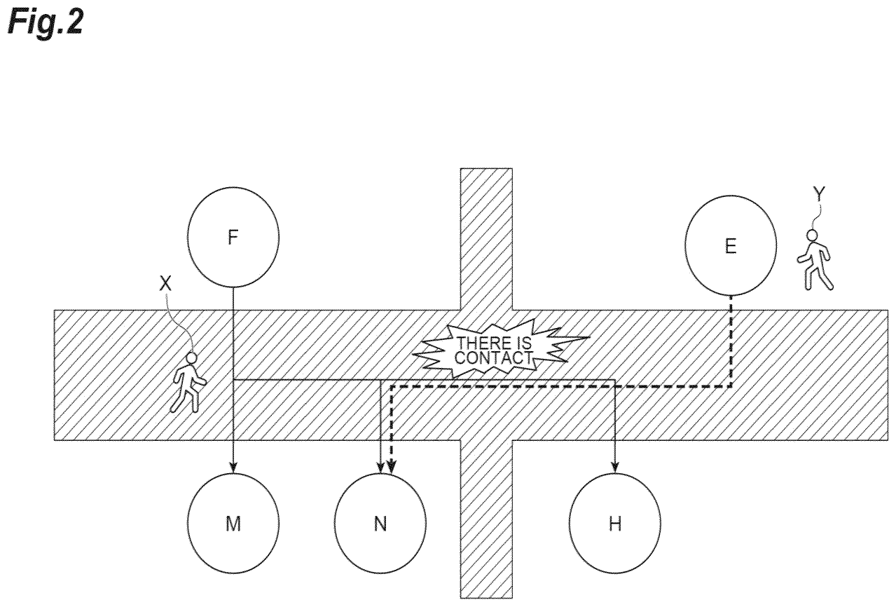

FIG. 2 is a diagram illustrating a simple usage image of the stay POI estimation device 1. In the usage image illustrated in FIG. 2, there are a store F, a store E, a store M, a store N, and a store H. It is assumed that a customer X who is the user stays in any store after making a payment in the store F. By making a payment in the store F, it is determined that the customer X stays in the store F. The stay POI estimation device 1 estimates where the customer X goes, that is, which store the customer X stays after staying in the store F. In FIG. 2, an arrow with a solid line indicates a route candidate of the customer X. Here, it is assumed that a customer Y who is another user makes a payment in the store N after making a payment in the store E. That is, it is determined that the customer Y stays in the store N after staying in the store E. In FIG. 2, an arrow with a broken line indicates the route of the customer Y. As illustrated in FIG. 2, it is assumed that the customer X and the customer Y are in contact with each other in the vicinity of the store N and the store H.

First, the stay POI estimation device 1 considers a movement time when estimating to which store of the store E, the store M, the store N, and the store H the customer X goes. In consideration of the movement time, it is obvious that the customer X goes to the store M, the store N, or the store H where the customer X arrives within the movement time. Next, the stay POI estimation device 1 considers contact determination. Since there is contact determination between the customer X and the customer Y, it is obvious that the customer X goes to the store N or the store H in the vicinity where there is the contact determination. In addition, in a case where the customer X is in the store N, it is obvious that the customer X is specified as staying in the store N by the payment information of the customer Y, or otherwise, the stay POI estimation device 1 estimates that the customer X stays in the store H.

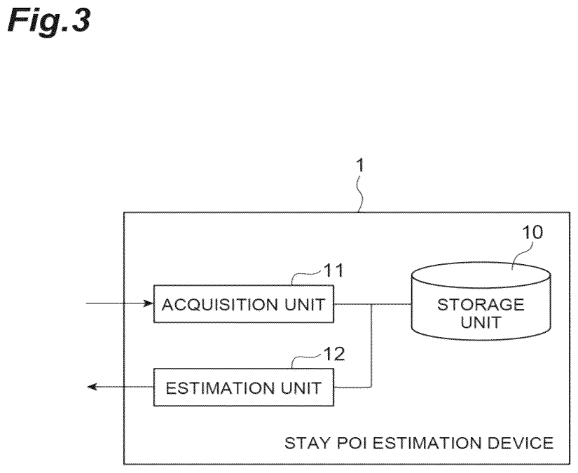

FIG. 3 is a diagram illustrating an example of a functional configuration of the stay POI estimation device 1 according to the embodiment. As illustrated in FIG. 3, the stay POI estimation device 1 is configured by including a storage unit 10, an acquisition unit 11, and an estimation unit 12 (an estimation unit).

Each function block of the stay POI estimation device 1 is assumed to function in the stay POI estimation device 1, but is not limited thereto. For example, a part of the function blocks of the stay POI estimation device 1 may function in a computer device that is different from the stay POI estimation device 1 and is connected to the stay POI estimation device 1 via a network while suitably transmitting and receiving information with respect to the stay POI estimation device 1. In addition, a part of the function blocks of the stay POI estimation device 1 may not be provided, a plurality of function blocks may be integrated into one function block, or one function block may be decomposed into a plurality of function blocks.

Hereinafter, each function of the stay POI estimation device 1 illustrated in FIG. 3 will be described.

The storage unit 10 stores any information used for computation or the like in the stay POI estimation device 1, a result of the computation in the stay POI estimation device 1, and the like. The information stored by the storage unit 10 may be suitably referred to by each function of the stay POI estimation device 1.

The storage unit 10 stores user information that is a chronological history of a stay during movement, a part of which is associated with the POI in which the user stays, and adjacency to the other user. The details of the user information will be described in the following specific examples (as visit POI information).

The acquisition unit 11 acquires any information from another device via the network, and stores the information by the storage unit 10. For example, the acquisition unit 11 acquires the BLE contact information, the payment information, the position information, the acceleration information, the other information acquired by the function or the sensor of the mobile terminal 2, and the like from the mobile terminal 2, and stores the information by the storage unit 10. In addition, for example, the acquisition unit 11 acquires user information, map information relevant to a map, POI information relevant to the POI, and the like from an external server, and stores the information by the storage unit 10.

The acquisition unit 11 may process the acquired information, and then, may store the information by the storage unit 10. For example, the acquisition unit 11 generates the user information for each user, on the basis of the acquired BLE contact information, payment information, position information, and acceleration information, and stores the generated user information by the storage unit 10.

The estimation unit 12 estimates a stay POI that is the POI in which the user stays in an unassociated stay that is a stay not associated with the POI, among stays included in the user information that is the chronological history of the stay during movement of each user, a part of which is associated with the POI in which the user stays, and the adjacency of each user to the other user, on the basis of the user information. The estimation unit 12 performs a simulation assuming that the user moves via a POI candidate that is a candidate of the stay POI for each user, and estimates the stay POI from the POI candidate, on the basis of a chronological match between adjacency between users extracted in the simulation and adjacency included in the user information.

The estimation unit 12 may determine the POI candidate of the user, on the basis of at least one of the stay of the user immediately before the unassociated stay and the stay of the user immediately after the unassociated stay. The estimation unit 12 may determine the POI candidates of each of users in contact with each other in the unassociated stay by narrowing down the POI candidates to POI candidates overlapping each other among the POI candidates determined for each of the users. The estimation unit 12 may group users in contact with each other in a predetermined period, and may perform the simulation in the predetermined period for each group.

The estimation unit 12, on the basis of the number of matches in the simulation, may compute the estimation accuracy of the stay POI. The estimation unit 12, on the basis of the number of matches in the simulation with respect to one POI candidate, may compute the estimation accuracy of the one POI candidate. The estimation unit 12, on the basis of the number of matches in the simulation, and the number of matches in the simulation with respect to the one POI candidate, may compute the estimation accuracy with respect to the one POI candidate.

The estimation unit 12 may output an estimation result that is estimated, and the estimation accuracy that is computed. The output, for example, may be displayed on a display that is one of output devices 1006 described below, or may be transmitted to another device via a communication device 1004 described below.

Hereinafter, the details of the stay POI estimation device 1, in particular, the estimation unit 12 will be described by using specific examples. A processing subject in the following specific examples is mainly the estimation unit 12. In order to improve the readability of the description, the subject (the estimation unit 12) will be omitted as appropriate.

The calculation flow of the estimation unit 12 is as follows.
1. Preprocessing
a. acquire the visit POI information of each user
b. acquire the map data
c. for an unspecified visit store of each user, list the stores in order of plausibility from the viewpoint of the movement time
2. Main Processing
a. extract the visit POI information of all users in a certain period of time
b. label the users with the contact information as a group
(1) narrow down the stores to stores overlapping each other between the users
(2) perform a grid-search on store candidates of each user for each group (in a case where a plurality of stores match with a condition, output a match rate of each store)
(3) carry out (2) on another group
c. update a target time zone, and return to 2.a
3. Update of Visit POI Information

### [Calculation 1]

The estimation unit 12 performs the preprocessing of Calculations 1.a to 1.c.

[Calculation 1.a]

The estimation unit 12 acquires the visit POI (store) information (the user information) of each user that is stored by the storage unit 10.

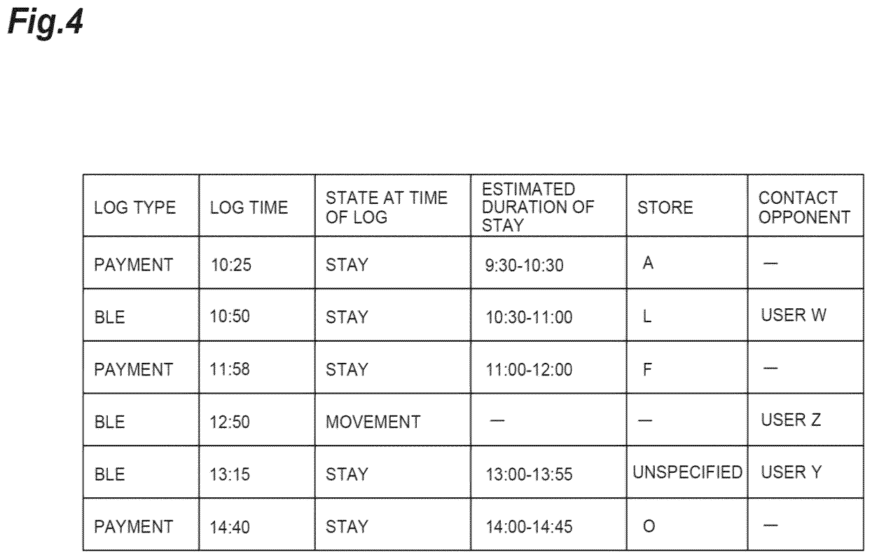

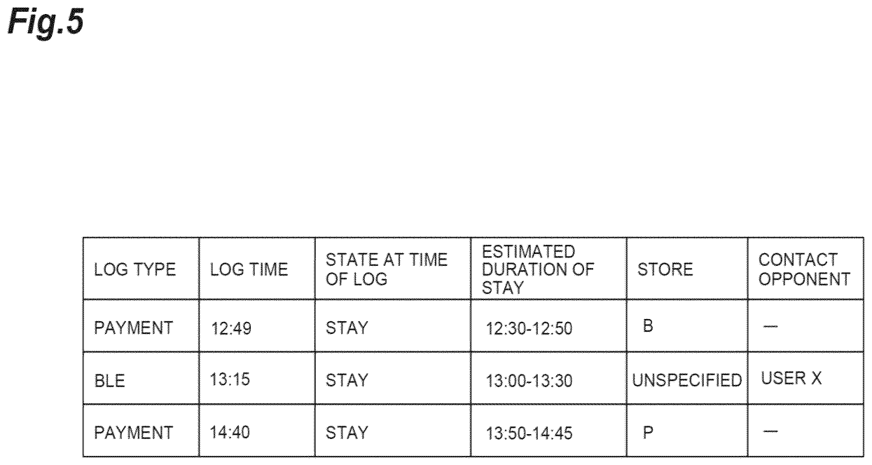

FIG. 4 is a diagram illustrating a table example of visit POI information (1) of a user X. In the visit POI information (1) illustrated in FIG. 4, a log type (such as a payment and BLE) indicating the type of log (visit POI information), a log time that is a time when the log is taken, a state at the time of log that is the state (such as a stay and a movement) of (the mobile terminal 2 carried by) the user X at the time, an estimated duration of stay that is the duration of stay estimated when the state at the time of log is a stay, a store that is a visited store (POI) associated with a stay when the state at the time of log is the stay and there is the store (POI) associated with the stay (in a case where there is no associated visited store, “unspecified”), and a contact opponent who is the other user in contact with (adjacent to) the user X at the time are associated with each other. FIG. 5 is a diagram illustrating a table example of visit POI information (1) of a user Y, and is the same as FIG. 4.

[Calculation 1.b]

The estimation unit 12 acquires the map data stored by the storage unit 10 for use in the simulation. The map data is in any form insofar as the map data is capable of calculating the movement time and reproducing the movement of the user (the person) between the stores.

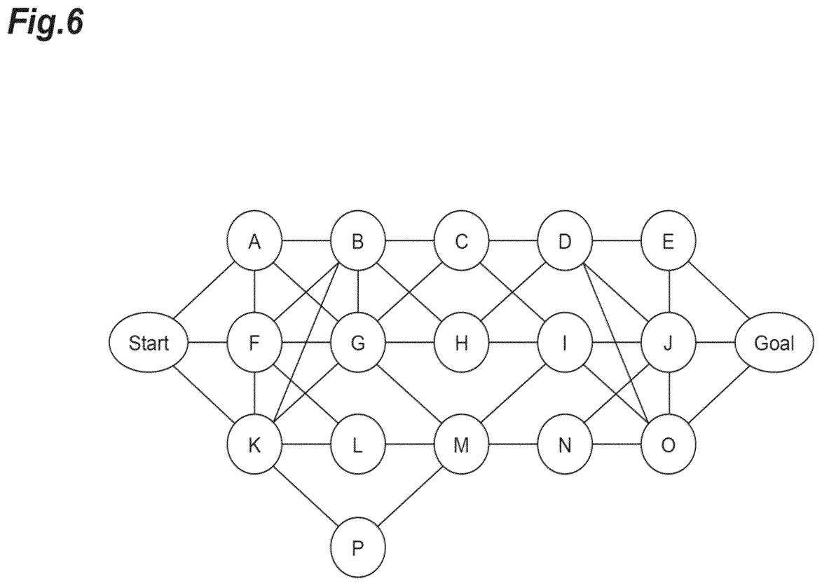

FIG. 6 is a diagram illustrating an (first) example of the map data. The map data in FIG. 6 is illustrated as a graph in which each POI is represented as a node, and a movement between the POIs is represented as a link (an edge) (in a graph theory).

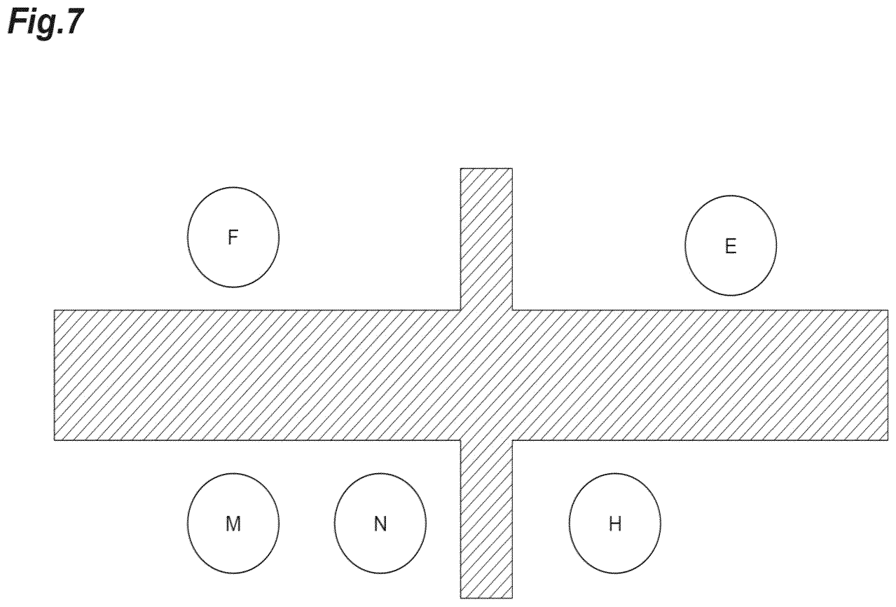

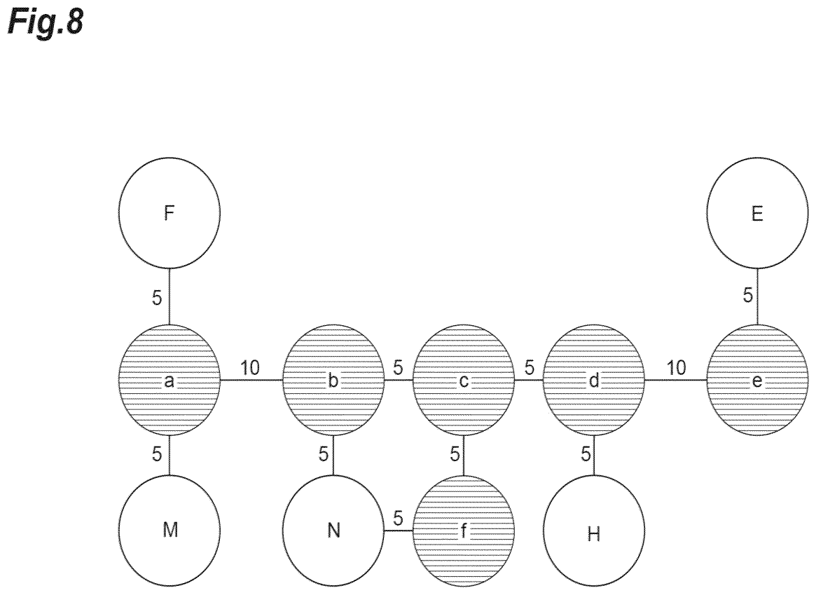

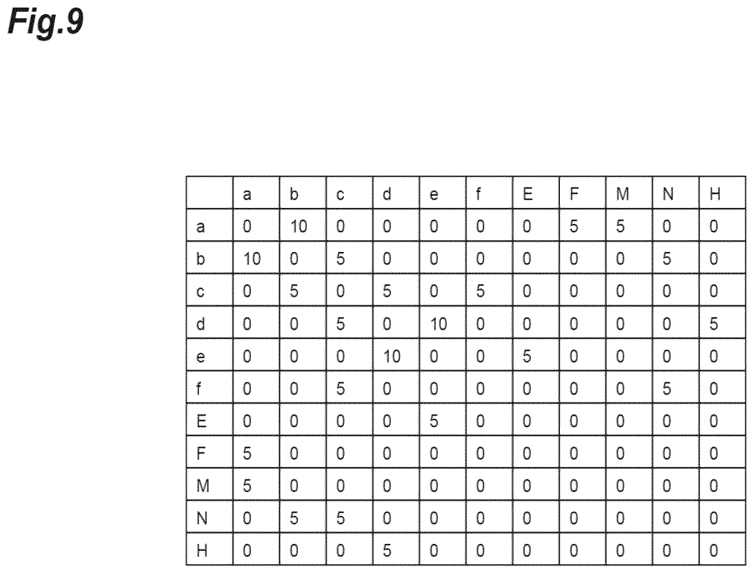

FIG. 7 is a diagram illustrating an (second) example of the map data. The map data illustrated in FIG. 7 is map data using the usage image illustrated in FIG. 2. FIG. 8 is a diagram illustrating the decomposition of the map data illustrated in FIG. 7 into node links. In FIG. 8, nodes a to f correspond to cross-points between the stores, and the like. A number (=a weight) on the link represents a distance (or the movement time) between the nodes. FIG. 9 is a diagram illustrating a table example of a weighted adjacency matrix corresponding to the node link illustrated in FIG. 8. The adjacency matrix illustrated in FIG. 9 is generated on the basis of the number on the link in FIG. 8 and the node to which the link is connected.

[Calculation 1.c]

For the unspecified visit stores of each user, the estimation unit 12 lists the stores in order of plausibility from the viewpoint of the movement time. For example, for a log in which the store in the visit POI information (1) of the user X illustrated in FIG. 4 is “unspecified”, the estimation unit 12 lists a “(since the user stays in the store F until 12:00, and stays in the current position from 13:00) store to which a movement is available from the store F within 1 hour” and a “(since the user stays in the current position from 13:55 and stays in a store O at 14:00) store from which the user arrives at the store O within 5 minutes”, on the basis of the estimated duration of previous stay and subsequent stay. For example, as the store candidate, the store N, a store J, a store I, the store E, a store D, and the store H are listed. The estimation unit 12 carries out the listing of (lists) the stores for all the users.

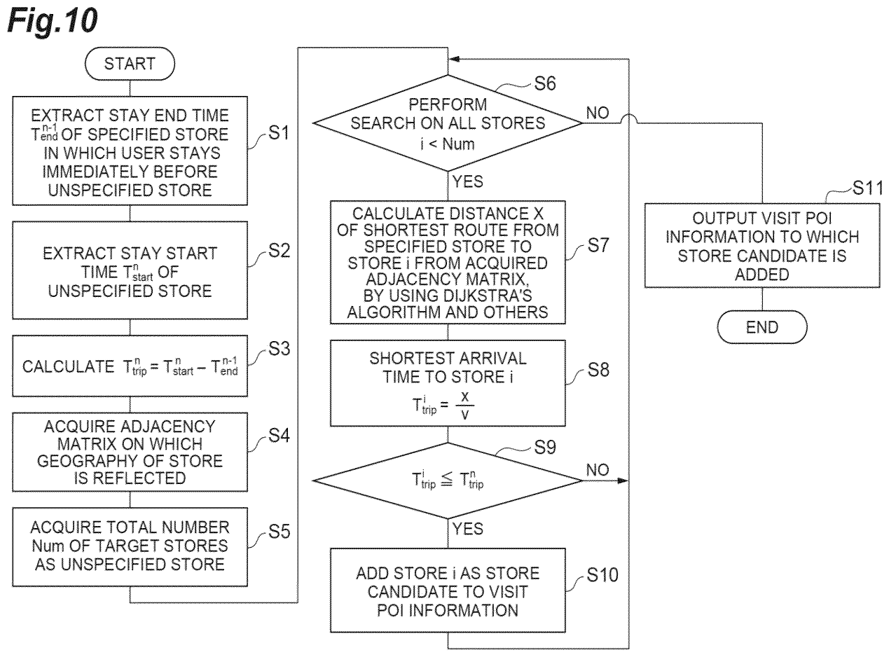

FIG. 10 is a flowchart illustrating an example of a store candidate extraction algorithm executed by the stay POI estimation device 1. First, a stay end time of a specified store in which the user stays immediately before the unspecified store

$${T}_{end}^{n - 1} \qquad [ Mathematical Formula 1 ]$$

is extracted (step S1). Next, a stay start time of the unspecified store

$${T}_{start}^{n} \qquad [ Mathematical Formula 2 ]$$

is extracted (step S2). Next,

$${T}_{trip}^{n} = {T}_{start}^{n} - {T}_{end}^{n - 1} \qquad [ Mathematical Formula 3 ]$$

is calculated (step S3). Next, the adjacency matrix on which the geography of the store is reflected is acquired (step S4). Next, the total number Num of target stores is acquired as the unspecified store (step S5).

Next, a search is performed on all the stores. First, whether i is less than Num is determined (step S6). In a case where it is determined that i is less than Num in S6 (S6: Yes), a distance X of the shortest route from the specified store to a store i is computed from the acquired adjacency matrix, by using a Dijkstra's algorithm or the like (step S7). Next, the shortest arrival time to the store i

$${T}_{trip}^{i} = \frac{X}{v} \qquad [ Mathematical Formula 4 ]$$

is computed (step S8). Here, v represents a speed. For example, in general, v=80 m/s is adopted. Next, whether

$${T}_{trip}^{i} \qquad [ Mathematical Formula 5 ]$$

is less than or equal to

$${T}_{trip}^{n} \qquad [ Mathematical Formula 6 ]$$

$${T}_{trip}^{i}$$

is determined (step S9). In a case where it is determined that

$${T}_{trip}^{n}$$

is less than or equal to in S9 (S9: Yes), the store i is added as the store candidate to the visit POI information (step S10). In a case where it is determined that

$${T}_{trip}^{i}$$

is not less than or equal to

$${T}_{trip}^{n}$$

subsequent to S10 or in S9 (S9: No), the processing returns to S6 (after incrementing i). In a case where it is determined that i is not less than Num in S6 (S6: No), the visit POI information to which the store candidate is added is output (step S11).

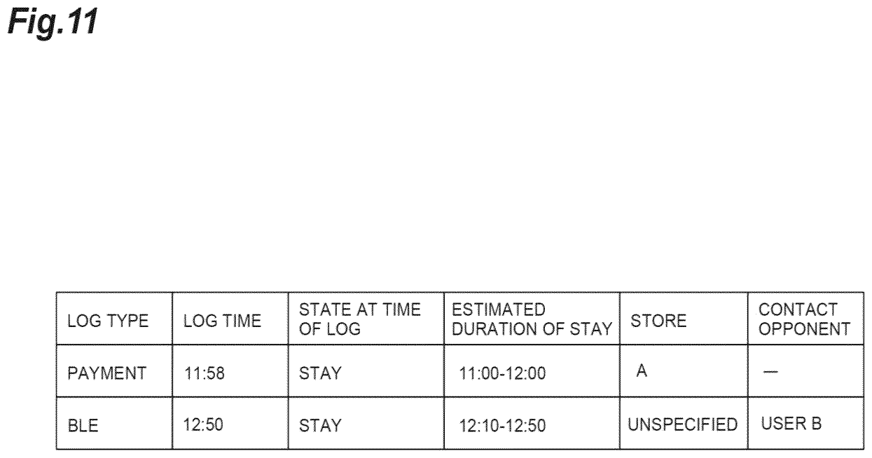

A case where a start point or an end point of a visit store is the unspecified store will be described. FIG. 11 is a diagram illustrating a table example of visit POI information (1) of a user A. In FIG. 11, the end point of the visit store is the unspecified store. In this case, as a store to which a movement is available from a store A within 10 minutes, seven stores of a store B, a store C, a store G, the store H, a store K, a store L, and the store F are listed. The number of candidate stores increases and a simulation execution time increases, compared to a case where the start point and the end point are specified, but the same processing is available.

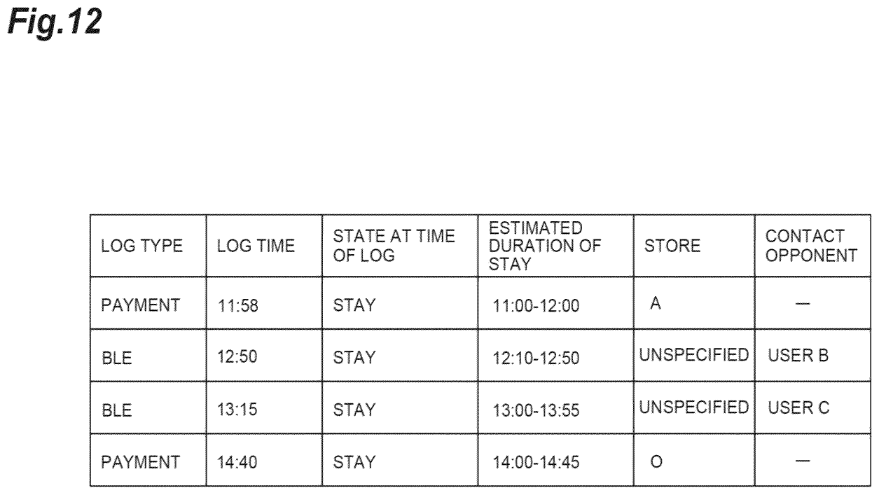

A case where there are a plurality of unspecified stores will be described. FIG. 12 is a diagram illustrating another table example of the visit POI information (1) of the user A. In FIG. 12, there are two unspecified stores. In this case, first, seven stores of the store B, the store C, the store G, the store H, the store K, the store L, and the store F are listed as the first store to which a movement is available from the store A within 10 minutes (12:00 to 12:10). Next, four stores of the store E, the store J, the store N, and the store I are listed as the second store to which a movement is available from the store O within 5 minutes (13:55 to 14:00). Next, in a combination of each of seven stores of the first store and each of four stores of the second store, that is, a combination of 7*4-28, a combination of the stores to which a movement is available within 10 minutes (12:50 to 13:00) is extracted (redundant combinations are excluded) and listed.

### [Calculation 2]

The estimation unit 12 performs the main processing of Calculations 2.a to 2.c.

[Calculation 2.a]

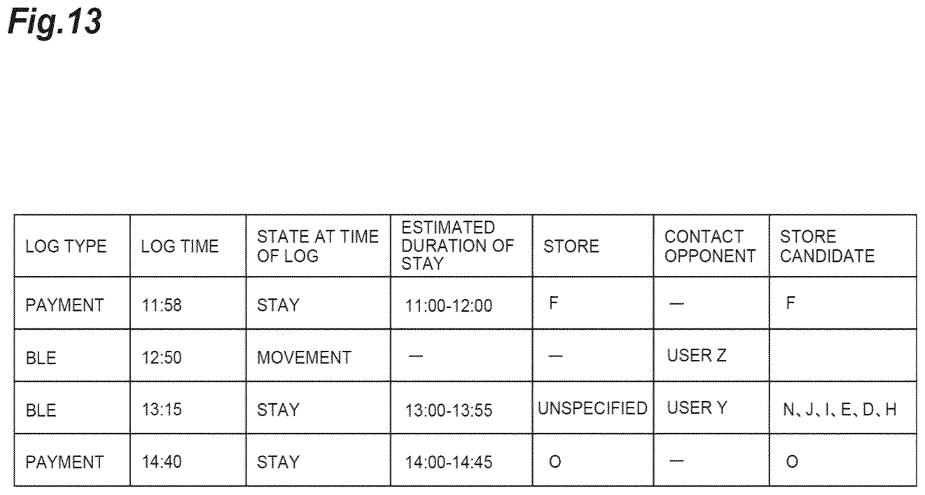

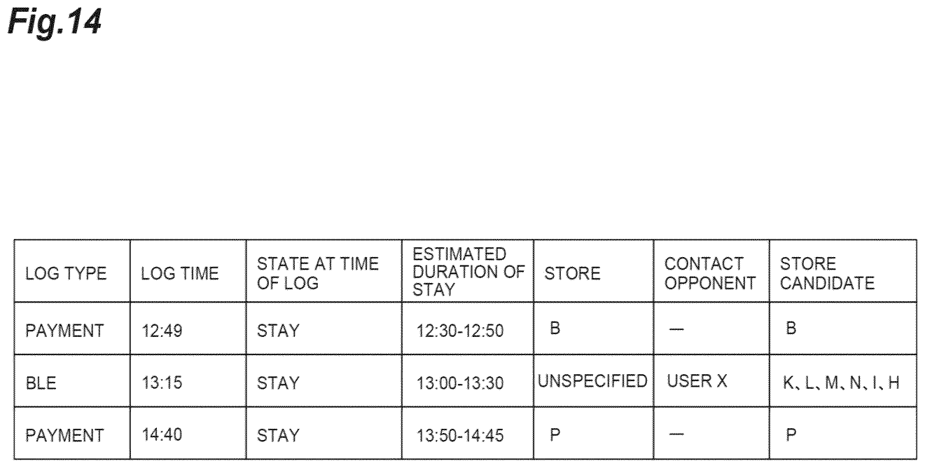

The estimation unit 12 extracts the visit POI information of all the users in a certain period of time. FIG. 13 is a diagram illustrating a table example of visit POI information (2) of the user X limited to 12:00 to 14:00. FIG. 14 is a diagram illustrating a table example of visit POI information (2) of the user Y limited to 12:00 to 14:00. In the visit POI information (2) of FIG. 13 and FIG. 14, the store candidates listed in Calculation 1.c are edited as a “Store Candidate” column.

[Calculation 2.b]

The estimation unit 12 labels the users with the contact information (within the time described above) as a group. For example, from the visit POI information (2) in FIG. 13 and FIG. 14, the user X, the user Y, and a user Z are labeled (grouped) as a group 1. Similarly, for example, the user A, the user B, and the like are labeled as a group 2.

[Calculation 2.b(1)]

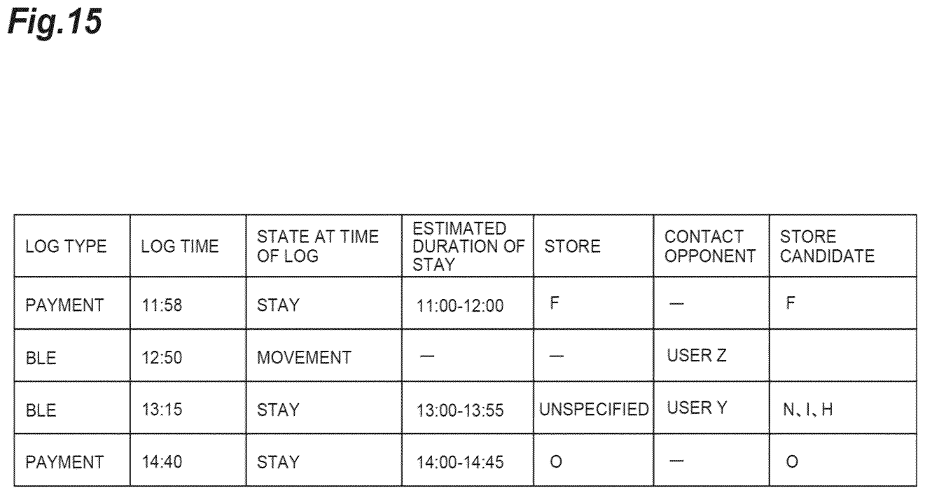

The estimation unit 12 narrows down the stores to the stores overlapping each other between the users. For example, in the visit POI information (2) of FIG. 13 and FIG. 14, since an overlap between the unspecified store candidates “N, J, I, E, D, H” of the user X and the unspecified store candidates “K, L, M, N, I, H” of the user Y is the store N, the store I, and the store H, the store candidates are narrowed down to the three store candidates. FIG. 15 is a diagram illustrating a table example of visit POI information (3) of the user X. As with the visit POI information (3) illustrated in FIG. 15, the store candidates are narrowed down to “N, I, H”. On the basis of the narrowed-down store candidates, the condition of a trial pattern described below is determined.

[Calculation 2.b(2)]

The estimation unit 12 performs a grid-search on the store candidates of each user for each group (in a case where a plurality of stores match with a condition, outputs a match rate of each store).

For example, a brute-force simulation is performed on the user X, the user Y, and the user Z, who are in a group 1, in accordance with the store candidates of each user. The number of trials is indicated by the following formula.

$$Number of trials = \{ Number of store candidates of users X and Y \times number of store candidates of user Z \} \times n$$

Here, n is the number of patterns of a random seed to be carried out. In the general simulation, a seed is set when using a random number, and n is a variable for determining how many seeds are used for validation.

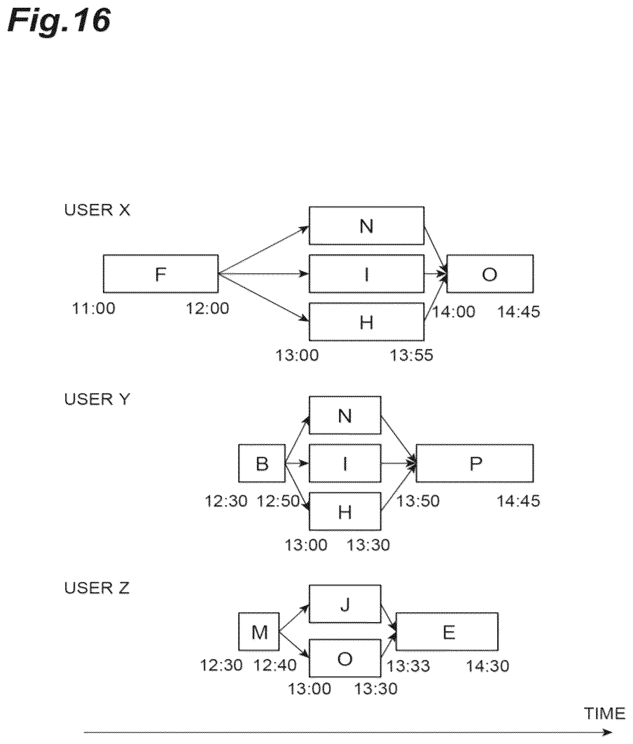

FIG. 16 is a diagram illustrating an example of a route for the brute-force simulation according to the store candidates of each user. As with the route illustrated in FIG. 16, the route via the store candidates is simulated.

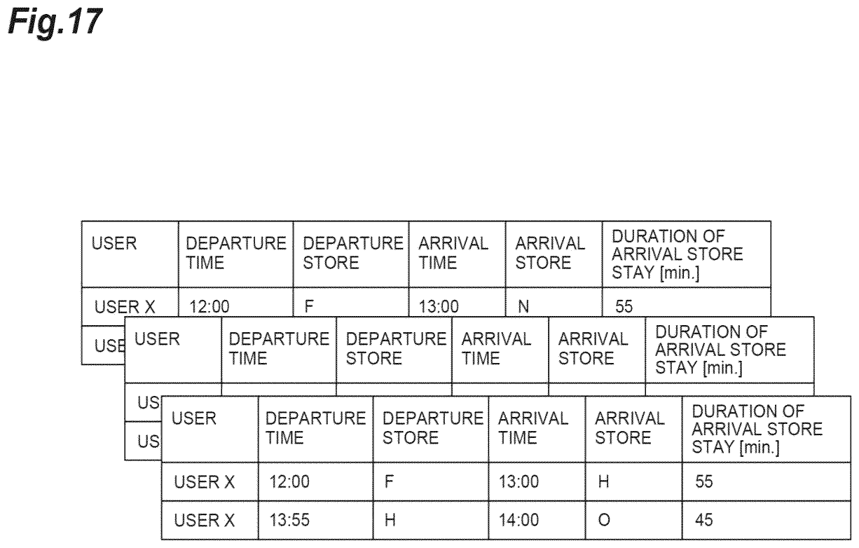

FIG. 17 is a diagram illustrating an example of input data of the simulation. In the input data illustrated in FIG. 17, a user ID for identifying the user, a departure time of the user, a departure store of the user, an arrival time of the user, an arrival store of the user, and the duration of arrival store stay that is the duration of stay in the arrival store of the user are associated with each other. The estimation unit 12 inputs the input data as illustrated in FIG. 17 to a simulator, and carries out a walking simulation, on the basis of the map data only for the number of trials.

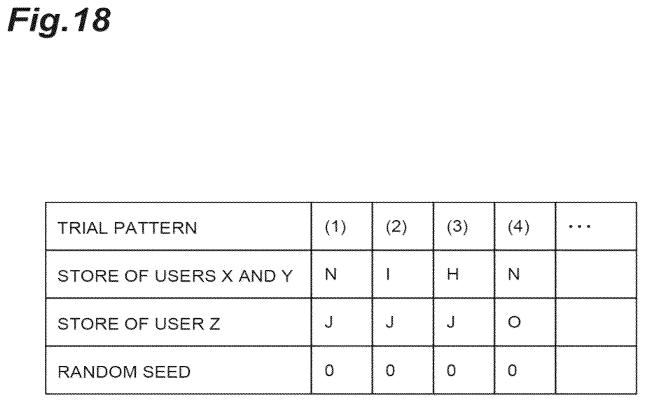

FIG. 18 is a diagram illustrating a table example of the trial pattern. In the trial pattern illustrated in FIG. 18, for each trial pattern, the store of the user X and the user Y (in contact with each other), the store of the user Z, and the random seed are associated with each other.

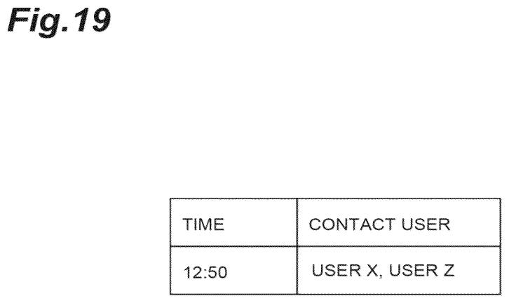

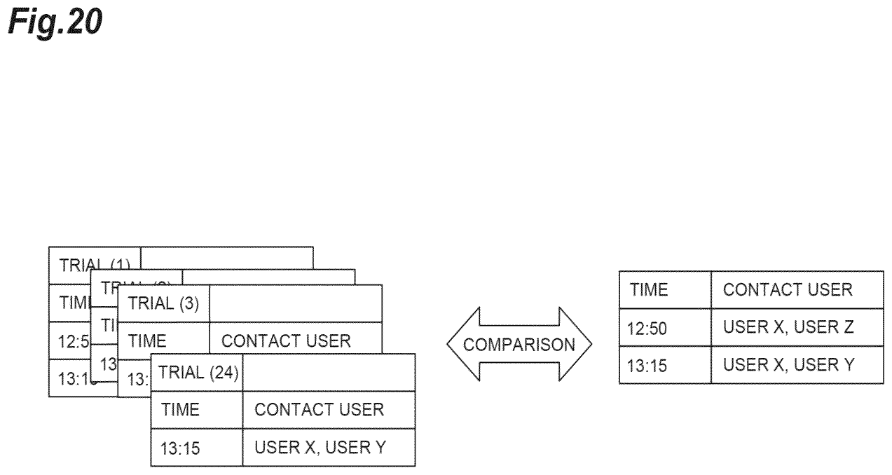

In order to reproduce the contact by BLE on the simulator, in a case where a distance between the users is a threshold value or less, the estimation unit 12 leaves a log (a contact log) representing the contact. FIG. 19 is a diagram illustrating a table example of the contact log. In the contact log illustrated in FIG. 19, a contact time and (a user ID of) a contact user who is a user in contact with the other user are associated with each other. The estimation unit 12 compares a log result (the number of log results is the same as the number of trial patterns) with the actual performance (such as the visit POI information (1)), and in a case where the contact log matches with the actual performance, extracts the matched trial. FIG. 20 is a diagram illustrating an example of a comparison between the log result of the contact log and the actual performance. In the comparison illustrated in FIG. 20, a trial is extracted in which the user X and the user Z, and the user X and the user Y are in contact with each other.

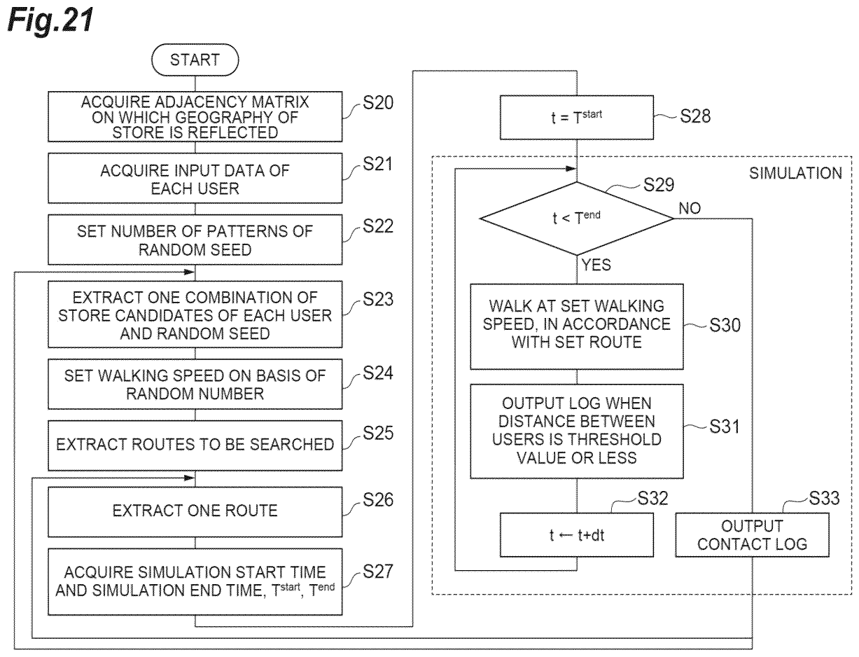

FIG. 21 is a flowchart illustrating an example of a walking simulation algorithm executed by the stay POI estimation device 1. First, the adjacency matrix on which the geography of the store is reflected is acquired (step S20). Next, the input data of each user is acquired (step S21). Next, the number of patterns of the random seed is set (step S22). Next, one combination of the store candidates of each user and the random seed is extracted (step S23). Specifically, one column of the trial pattern as illustrated in FIG. 18 is extracted. Next, a walking speed is set on the basis of the random number (step S24, the details will be described below). Next, routes to be searched are extracted (step S25, the details will be described below). Next, one route is extracted (step S26). Next, a simulation start time T^{start} and a simulation end time T^{end} are acquired (step S27). Next, t=T^{start} is set (step S28).

Next, whether t is less than T^{end} is determined (step S29). In a case where it is determined that t is less than T^{end} in S29 (S29: Yes), walking (the simulation) is performed at the set walking speed, in accordance with the set route (step S30). Next, in a case where the distance between the users is the threshold value or less, the log is output (step S31). Next, t is set to t+dt (step S32), the processing returns to S29. In a case where it is determined that t is not less than T^{end} in S29 (S29: No), the contact log is output (step S33). In a case where there is still the route to be searched subsequent to S33, the processing returns to S26, or otherwise, the processing returns to S23. The processing of S29 to S33 is simulated.

The details of the setting of the walking speed in S24 will be described. The walking speed of a user i is indicated by the following formula, in accordance with a normal distribution (unit is m/s).

$$vi \sim N ( μ , σ 2 ) \qquad [ Mathematical Formula 7 ]$$

Here, vᵢ is the walking speed of the user i, N is the normal distribution, μ (a parameter) is the average value of the walking speed, and σ (a parameter) is the standard deviation of the walking speed.

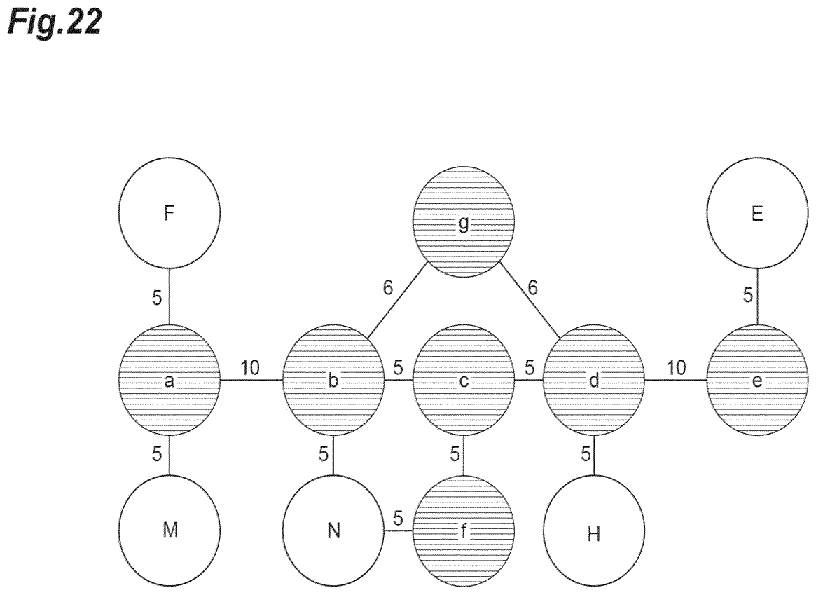

The details of the extraction of the search route in S25 will be described. As a premise, a node link illustrated in FIG. 22 will be referred to. FIG. 22 is a diagram illustrating the decomposition of an (third) example of the map data into the node links. In the node link illustrated in FIG. 22, as the shortest route from E to N, the following two routes are considered.
1. E→e→d→c→f→N
2. E→e→d→c→b→N

In addition, even though it is not the shortest route, the following route is also considered.
3. E→e→d→g→b→N

In order to extract, as a target route, a case where one shortest route is not set as with 1 and 2 and a case where there is a slight detour but no significant difference in the movement time as with 3, all the routes satisfying

$$( Route distance ) \leq ( Shortest route + {X}_{thres} )$$

may be extracted. Here, Xthres is a parameter.

[Calculation 2.b(3)]

The estimation unit 12 carries out (1) on another group.

[Calculation 2.c]

The estimation unit 12 updates the target time zone, and returns to Calculation 2.a.

### [Calculation 3]

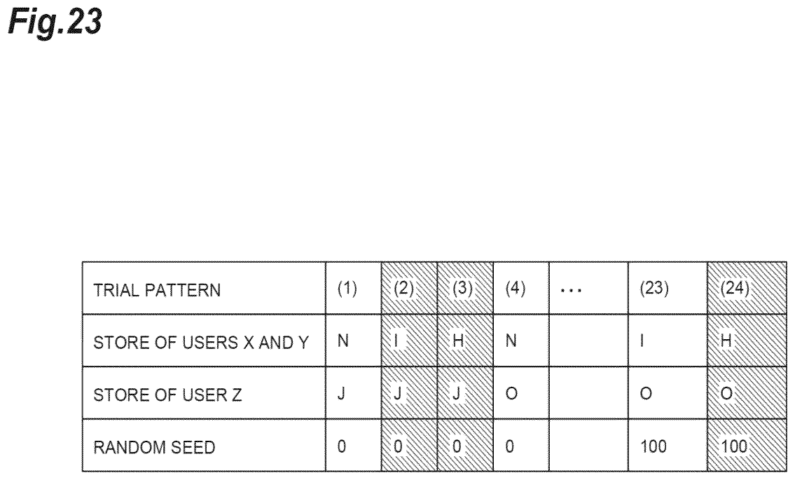

The estimation unit 12 updates the visit POI information. First, the estimation unit 12 distinguishes a trial pattern different from (not matching with) the actual performance, among the trial patterns, and sets the trial pattern as an extraction result. FIG. 23 is a diagram illustrating a table example of a trial pattern in which a difference from the actual performance is hatched.

In a case where M is set as the number of matches with BLE contact actual performance, the following formula is established.

$$M \leq Number of trials$$

In addition, in a case where N is set as the number of times in which the store is the store i within M trials, the following formula is established.

$${N}_{i} \leq M$$

The match rate of the store i is indicated by the following formula.

$${N}_{i} / M$$

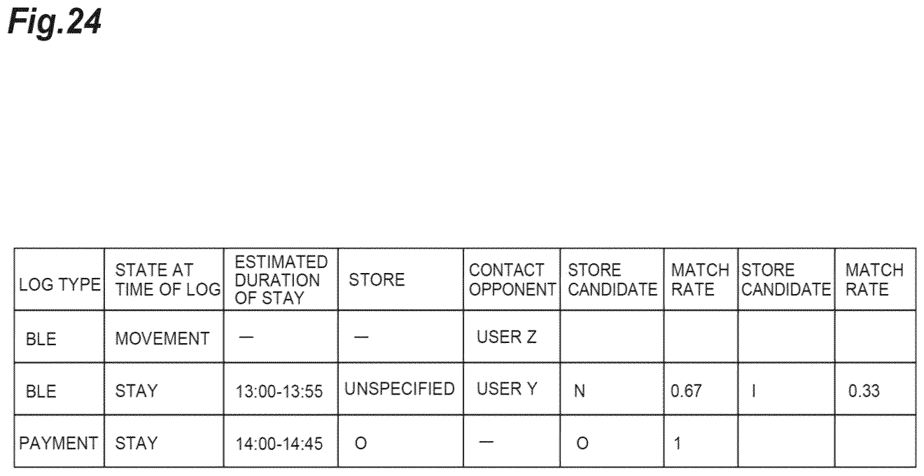

In the table example of FIG. 23, for example, M is 18, and the number N_{N} of times in which the store of the user X and the user Y is the store N is 12. In this case, the match rate of the store N for user X and the user Y is 12/18=0.67. FIG. 24 is a diagram illustrating a table example of visit POI information (4) of the user X. As illustrated in FIG. 24, one or more store candidates and the match rate thereof are edited to the unspecified store.

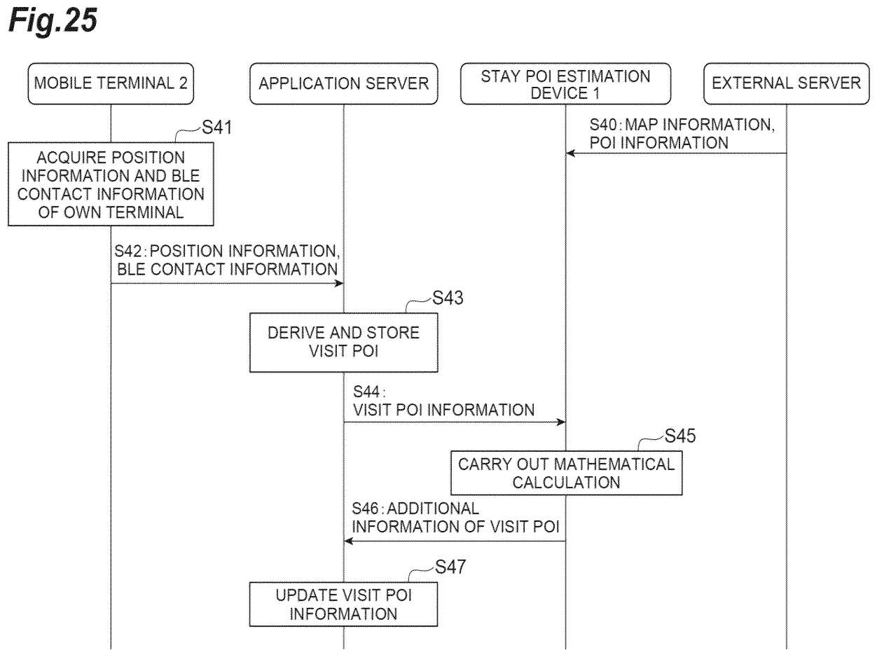

FIG. 25 is a sequence diagram illustrating an example of a processing flow executed by the stay POI estimation system 3 including the stay POI estimation device 1. First, the external server transmits the map information and the POI information to the stay POI estimation device 1 (step S40). Next, the mobile terminal 2 acquires the position information and the BLE contact information of the own terminal (step S41). Next, the mobile terminal 2 transmits the position information and the BLE contact information acquired in S41 to an application server (step S42). Next, the application server derives and stores the visit POI, on the basis of the position information and the BLE contact information received in S42 (step S43). Next, the application server transmits the visit POI information derived in S43 to the stay POI estimation device 1 (step S44). Next, the stay POI estimation device 1 carries out mathematical calculation (the simulation), on the basis of the map information and the POI information received in S40, and the visit POI information received in S44 (step S45). Next, the stay POI estimation device 1 transmits the additional information of the visit POI obtained in S45 to the application server (step S46). Next, the application server updates the (stored) visit POI information, on the basis of the additional information of the visit POI received in S46 (step S47).

In the sequence diagram illustrated in FIG. 25, the timing of S40 may be any time before S45. In addition, the application server may be included in the stay POI estimation device 1. That is, S42 may be transmitted to the stay POI estimation device 1, and S43, S45, and S47 may be performed in the stay POI estimation device 1.

Subsequently, the function effect of the stay POI estimation device 1 according to the embodiment will be described.

According to the stay POI estimation device 1, the stay POI estimation device 1 includes the estimation unit 12 estimating the stay POI that is the POI in which the user stays in the unassociated stay that is the stay not associated with the POI, among the stays included in the user information that is the chronological history of the stay during movement of each user, a part of which is associated with the POI in which the user stays, and the adjacency of each user to the other users, on the basis of the user information, the estimation unit 12 performing the simulation assuming that the user moves via the POI candidate that is the candidate of the stay POI for each user, and estimating the stay POI from the POI candidate, on the basis of the chronological match between the adjacency between the users extracted in the simulation and the adjacency included in the user information. According to such a configuration, the POI in which the user stays in the stay not associated with the POI among the stays during movement of the user is estimated. That is, it is possible to estimate the POI in which the user stays.

In addition, according to the stay POI estimation device 1, the estimation unit 12 may determine the POI candidate of the user, on the basis of at least one of the stay of the user immediately before the unassociated stay and the stay of the user immediately after the unassociated stay. According to such a configuration, since more accurate POI candidates based on at least one of the stay of the user immediately before the unassociated stay and the stay of the user immediately after the unassociated stay can be used, it is possible to perform more accurate estimation.

In addition, according to the stay POI estimation device 1, the estimation unit 12 may determine the POI candidates of each of the users in contact with each other in the unassociated stay by narrowing down the POI candidates to the POI candidates overlapping each other among the POI candidates determined for each of the users. According to such a configuration, since the POI candidates are narrowed down, it is possible to reduce the calculation amount of the simulation, and perform faster estimation.

In addition, according to the stay POI estimation device 1, the estimation unit 12 may group the users in contact with each other in a predetermined period, and may perform the simulation in the predetermined period for each group. According to such a configuration, it is possible to reduce the calculation amount of the simulation, and perform faster estimation.

In addition, according to the stay POI estimation device 1, the estimation unit 12, on the basis of the number of matches in the simulation, may compute the estimation accuracy of the stay POI. According to such a configuration, for example, it is possible to grasp not only the estimation result but also the estimation accuracy.

In addition, according to the stay POI estimation device 1, the estimation unit 12, on the basis of the number of matches in the simulation with respect to one POI candidate, may compute the estimation accuracy of the one POI candidate. According to such a configuration, for example, it is possible to grasp not only the estimation result but also the estimation accuracy.

In addition, according to the stay POI estimation device 1, the estimation unit 12, on the basis of the number of matches in the simulation, and the number of matches in the simulation with respect to the one POI candidate, may compute the estimation accuracy of the one POI candidate. According to such a configuration, for example, it is possible to grasp not only the estimation result but also the estimation accuracy.

The stay POI estimation device 1 is a visit store complementation technology based on numerical calculation.

In general, in order to measure the effect of measures and advertisements relevant to a commercial facility and analyze the users, it is preferable that which store is visited by a user unit can be accurately determined. As a method for determining a store visit, the use of the position information and the utilization of the payment history are considered, but it is difficult to acquire the position information and the information of the payment history of all the users.

The stay POI estimation device 1 carries out the walking simulation, on the basis of the visit POI (store) that is capable of being specified by the existing technology, and for the store that is not capable of being specified, estimates the visit POI (store) that is spatial-temporally plausible from the BLE contact information between the users.

The stay POI estimation device 1 is a device estimating the appropriate visit store of the user, and may be a system presenting a store that the user is likely to visit together with the accuracy thereof by utilizing a contact detection technology represented by BLE and a simulation technology in a case where it is not possible to estimate the visit store of the user only with the position information and the payment information. According to the stay POI estimation device 1, by carrying out the simulation for each group, it is possible to narrow down the users to users of interest, which is expected to improve the execution efficiency of the simulation.

Note that in this embodiment, the orders of “listing the store candidates”, “delimiting the certain period of time”, and “delimiting the group” may be interchanged from the viewpoint of an execution speed. In addition, the specification of the table can be any format insofar as the same calculation processing can be performed. In addition, a technology in which the same contact determination can be performed, such as not only BLE but also infrared communication or the like, may be premised.

The stay POI estimation device 1 of the present disclosure may have the following configurations.

[1] A stay point of interest (POI) estimation device, comprising an estimation unit estimating a stay POI that is a POI in which a user stays in an unassociated stay that is a stay not associated with the POI, among stays comprised in user information that is a chronological history of a stay during movement of each user, a part of which is associated with the POI in which the user stays, and adjacency of each user to other users, on the basis of the user information, the estimation unit performing a simulation assuming that the user moves via a POI candidate that is a candidate of the stay POI for each user, and estimating the stay POI from the POI candidate, on the basis of a chronological match between adjacency between users extracted in the simulation and adjacency comprised in the user information.

[2] The stay POI estimation device according to [1],
in which the estimation unit determines the POI candidate of the user, on the basis of at least one of a stay of the user immediately before the unassociated stay and a stay of the user immediately after the unassociated stay.

[3] The stay POI estimation device according to [1] or [2],
in which the estimation unit determines POI candidates of each of users in contact with each other in the unassociated stay by narrowing down the POI candidates to POI candidates overlapping each other among the POI candidates determined for each of the users.

[4] The stay POI estimation device according to any one of [1] to [3],
in which the estimation unit groups users in contact with each other in a predetermined period, and performs the simulation in the predetermined period for each group.

[5] The stay POI estimation device according to any one of [1] to [4],
in which the estimation unit, on the basis of the number of matches in the simulation, computes an estimation accuracy of the stay POI.

[6] The stay POI estimation device according to any one of [1] to [5],
in which the estimation unit, on the basis of the number of matches in the simulation with respect to one POI candidate, computes an estimation accuracy of the one POI candidate.

[7] The stay POI estimation device according to any one of [1] to [6],
in which the estimation unit, on the basis of the number of matches in the simulation, and the number of matches in the simulation with respect to one POI candidate, computes an estimation accuracy of the one POI candidate.

Note that a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating (mapping), assigning, and the like, but is not limited thereto. For example, the function block (the configuration unit) performing the transmitting is referred to as a transmitting unit or a transmitter. In either case, as described above, a method for attaining the function block is not particularly limited.

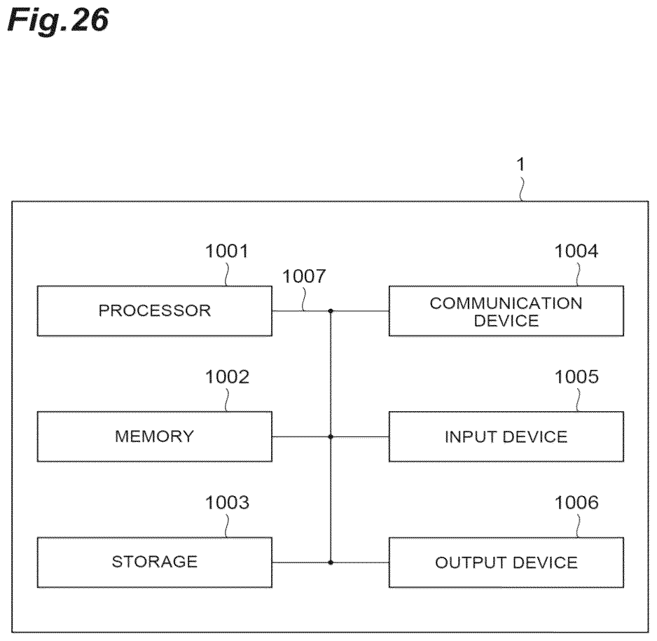

For example, the stay POI estimation device 1 or the like in one embodiment of the present disclosure may function as a computer performing the processing of a stay POI estimation method of the present disclosure. FIG. 26 is a diagram illustrating an example of a hardware configuration of the stay POI estimation device 1 according to one embodiment of the present disclosure. The stay POI estimation device 1 described above may be physically configured as a computer device including a processor 1001, a memory 1002, a storage 1003, a communication device 1004, an input device 1005, an output device 1006, a bus 1007, and the like.

Note that in the following description, the word “device” can be replaced with a circuit, a unit, or the like. The hardware configuration of the stay POI estimation device 1 may be configured to include one or a plurality of devices illustrated in the drawings, or may be configured to exclude some devices.

Each of the functions in the stay POI estimation device 1 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, the acquisition unit 11, the estimation unit 12, and the like described above may be attained by the processor 1001.

In addition, the processor 1001 reads out a program (a program code), a software module, data, and the like from at least one of the storage 1003 and the communication device 1004 to the memory 1002, and executes various pieces of processing in accordance with the program and the like. As the program, a program for causing a computer to execute at least a part of the operation described in the above embodiment is used. For example, the acquisition unit 11 and the estimation unit 12 may be attained by a control program that is stored in the memory 1002 and operated in the processor 1001, and the other function blocks may be similarly attained. It has been described that the various pieces of processing described above are executed by one processor 1001, but the various pieces of processing may be simultaneously or sequentially executed by two or more processors 1001. The processor 1001 may be implemented by one or more chips. Note that the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out a wireless communication method according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. The storage medium described above, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred as a network device, a network controller, a network card, a communication module, and the like. The communication device 1004, for example, may be configured by including a high-frequency switch, a duplexer, a filter, a frequency synthesizer, and the like in order to attain at least one of frequency division duplex (FDD) and time division duplex (TDD). For example, the acquisition unit 11, the estimation unit 12, and the like described above may be attained by the communication device 1004.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the stay POI estimation device 1 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The notifying of the information is not limited to the aspects/embodiments described in the present disclosure, and may be performed by using other methods.

Each of the aspects/embodiments described in the present disclosure may be applied to at least one of a system using long term evolution (LTE), LTE-advanced (LTE-A), SUPER 3G, IMT-advanced, a 4th generation (4G) mobile communication system, a 5th generation (5G) mobile communication system, future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems, and a next generation system extended based thereon. In addition, a plurality of systems may be applied in combination (for example, a combination between at least one of LTE and LTE-A and 5G, or the like)

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The determining may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The information, the signal, and the like described in the present disclosure may be represented by using any of various different technologies. For example, data, an instruction, a command, information, a signal, a bit, a symbol, a chip, and the like that can be mentioned over the entire description may be represented by a voltage, a current, an electromagnetic wave, a magnetic field or magnetic particles, an optical field or a photon, or any combination thereof.

Note that terms described in the present disclosure and terms required to understand the present disclosure may be replaced with terms having the same or similar meanings.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The names used for the parameters described above are not a limited name in any respect. Further, a mathematical formula or the like using such parameters may be different from that explicitly disclosed in the present disclosure.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

The “means” in the configuration of each of the devices described above may be replaced with a “unit”, a “circuit”, a “device”, and the like.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### REFERENCE SIGNS LIST

1 . . . stay POI estimation device, 2 . . . mobile terminal, 3 . . . stay POI estimation system, 10 . . . storage unit, 11 . . . acquisition unit, 12 . . . estimation unit, 1001 . . . processor, 1002 . . . memory, 1003 . . . storage, 1004 . . . communication device, 1005 . . . input device, 1006 . . . output device, 1007 . . . bus.

1. A stay point of interest (POI) estimation device, comprising processing circuitry configured to
estimate a stay POI that is a POI in which a user stays in an unassociated stay that is a stay not associated with the POI, among stays comprised in user information that is a chronological history of a stay during movement of each user, a part of which is associated with the POI in which the user stays, and adjacency of each user to other users, on the basis of the user information, wherein the processing circuitry is further configured to perform a simulation assuming that the user moves via a POI candidate that is a candidate of the stay POI for each user, and estimating the stay POI from the POI candidate, on the basis of a chronological match between adjacency between users extracted in the simulation and adjacency comprised in the user information.

2. The stay POI estimation device according to claim 1,
wherein the processing circuitry is further configured to determine the POI candidate of the user, on the basis of at least one of a stay of the user immediately before the unassociated stay and a stay of the user immediately after the unassociated stay.

3. The stay POI estimation device according to claim 2,
wherein the processing circuitry is further configured to determine POI candidates of each of users in contact with each other in the unassociated stay by narrowing down the POI candidates to POI candidates overlapping each other among the POI candidates determined for each of the users.

4. The stay POI estimation device according to claim 1,
wherein the processing circuitry is further configured to group users in contact with each other in a predetermined period, and performs the simulation in the predetermined period for each group.

5. The stay POI estimation device according to claim 1,
wherein the processing circuitry is further configured to, on the basis of the number of matches in the simulation, compute an estimation accuracy of the stay POI.

6. The stay POI estimation device according to claim 1,
wherein the processing circuitry is further configured to, on the basis of the number of matches in the simulation with respect to one POI candidate, compute an estimation accuracy of the one POI candidate.

7. The stay POI estimation device according to claim 1,
wherein the processing circuitry is further configured to, on the basis of the number of matches in the simulation, and the number of matches in the simulation with respect to one POI candidate, compute an estimation accuracy of the one POI candidate.
